(19) United States
(12) Patent Application Publication
(10) Pub. No.: US 2014/0032232 A1
(43) Pub. Date: Jan. 30, 2014

(54) Quality Compliance System for Refurbishment of Medical Device

(71) Applicants: Robert Bosch GmbH, Stuttgart (DE); Robert Bosch Healthcare Systems, Inc., Palo Alto, CA (US)

(72) Inventors: Stephen J. Brown, Woodside, CA (US); Michael Howells, Palo Alto, CA (US)

(73) Assignees: Robert Bosch GmbH, Stuttgart (DE); Robert Bosch Healthcare Systems, Inc., Palo Alto, CA (US)

(21) Appl. No.: 13/950,934

(22) Filed: Jul. 25, 2013

Related U.S. Application Data
(60) Provisional application No. 61/675,542, filed on Jul. 25, 2012.

(51) Int. Cl. G06Q 30/00; G06Q 50/22

(52) U.S. Cl. CPC G06Q 30/018; G06Q 50/22
USPC 705/2

(57) ABSTRACT

In one embodiment, a quality compliance system for a medical device includes at least one medical device configured to diagnose, monitor, or treat a medical condition, the at least one medical device configured to lockout operation of the at least one medical device, a refurbishment device configured to establish a communication link with the at least one medical device, generate electronic documentation of a maintenance or service procedure on the at least one medical device, provide for associating a digital signature of an operator with the generated electronic documentation, transmit the digital signature and generated electronic documentation, and unlock the medical device with a received key, and a service application configured to receive the transmitted digital signature and generated electronic documentation, verify the transmitted digital signature and generated electronic documentation, and transmit the key to the refurbishment device upon verification of the transmitted digital signature and generated electronic documentation.

This application claims the benefit of U.S. Provisional Application No. 61/675,542 filed Jul. 25, 2012, the entire contents of which is herein incorporated by reference.

### FIELD OF THE INVENTION

This disclosure relates to systems used to ensure quality of refurbished medical devices.

### BACKGROUND

Medical devices are used for diagnosis, monitoring, and prevention or treatment of diseases. Some medical devices are designed to be temporarily used at a remote location such as the home of a patient. When the medical device is no longer needed by the initial patient, the medical device is retrieved from the initial patient and re-used by a second patient typically at a second location. By re-using medical devices, an issuer and the patients can realize significant savings.

Prior to re-use, the medical devices are refurbished. Refurbishment includes extensive testing of the device and excising data related to the previous user. In the event that any of the components of the medical device are not in an acceptable condition, the component is replaced or refurbished. After repair or replacement of components, the medical device is typically retested.

In some instances, testing and refurbishment of a medical device is most economically achieved by servicing the device in the field. In these instances, a field technician tests/replaces components and performs any needed maintenance procedures. Field technicians may further repair medical devices for continued use by the original patient. In both instances, known systems rely upon the field technician to properly test, repair, and return to service the medical device.

While the use of field technicians to test/replace components can be very cost effective, known approaches to using field technicians do not include sufficient safeguards against technician error. Consequently, it is possible for a device to be returned to service which is not operating at an optimal level.

What is needed is a system which provides increased quality assurance of the refurbishment/repair of medical devices. It would be advantageous if such a system was integrated with field repair/refurbishment procedures for medical devices. It would be further advantageous if the system ensured proper refurbishment prior to allowing the medical device to be returned to service.

### SUMMARY

The embodiments herein provide a system and method which can be used to ensure that a medical device at a remote location, such as at the home of a patient, is properly refurbished/serviced.

In one embodiment, a quality compliance system for a medical device includes at least one medical device configured to diagnose, monitor, or treat a medical condition, the at least one medical device configured to lockout operation of the at least one medical device, a refurbishment device configured to (i) establish a communication link with the at least one medical device, (ii) generate electronic documentation of a maintenance or service procedure on the at least one medical device, (iii) provide for associating a digital signature of an operator with the generated electronic documentation, (iv) transmit the digital signature and generated electronic documentation, and (v) unlock the at least one medical device with a received key, and a service application configured to receive the transmitted digital signature and generated electronic documentation, verify the transmitted digital signature and generated electronic documentation, and transmit the key to the refurbishment device upon verification of the transmitted digital signature and generated electronic documentation.

In another embodiment, a method of ensuring quality compliance for a medical device includes providing a medical device configured to diagnose, monitor, or treat a medical condition, locking out operation of the medical device, providing a refurbishment device, establishing a communication link between the refurbishment device and the medical device, generating electronic documentation of a maintenance or service procedure on the medical device using the refurbishment device, associating a digital signature of an operator with the generated electronic documentation using the refurbishment device, transmitting the digital signature and generated electronic documentation to a service application using the refurbishment device, verifying the transmitted digital signature and generated electronic documentation with the service application, transmitting a key from the service application to the refurbishment device upon verification of the transmitted digital signature and generated electronic documentation, and unlocking the medical device with the key using the refurbishment device.

Other features of the embodiments herein will be apparent from the drawings, and detailed description that follows below

### BRIEF DESCRIPTION OF THE DRAWINGS

FIG. 1 depicts a functional block diagram of a medical device quality compliance system;

FIG. 2 depicts a functional block diagram of a medical device in the medical device quality compliance system of FIG. 1;

FIG. 3 depicts a functional block diagram of a refurbishment device in the medical device quality compliance system of FIG. 1; and

FIG. 4 depicts a method of ensuring quality compliance in refurbishment or servicing of a medical device.

### DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

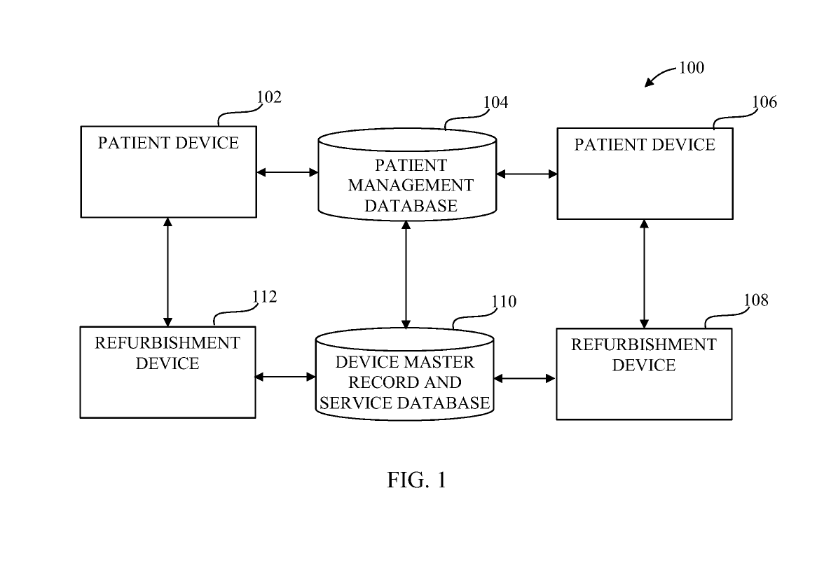

FIG. 1 depicts a functional block diagram of a medical device quality compliance system 100. The medical device quality compliance system 100 includes a medical device 102, a patient management database 104, a care manager application 106, a service application 108, a device master record and service database 110, and a refurbishment device 112. While only one medical device 102 is depicted, a typical medical device quality compliance system 100 includes multiple medical devices 102 of different types and models.

As depicted in FIG. 1, each of the components of the medical device quality compliance system 100 is in communication with at least one other component in the system through a communication network. The communication network may include one or more wired or wireless communication systems such as a local area network (LAN), a wireless area network (WAN), a virtual private network (VPN), the internet, etc. Moreover, while depicted as separate components, one or more of the components may be realized in a single device. Specifically, one or more of the patient management database 104, the care manager application 106, the service application 108, and the device master record and service database 110 may be co-located. Thus, for example, the patient management database 104 and the care manager application 106 may be stored in a common memory of a single server in some embodiments.

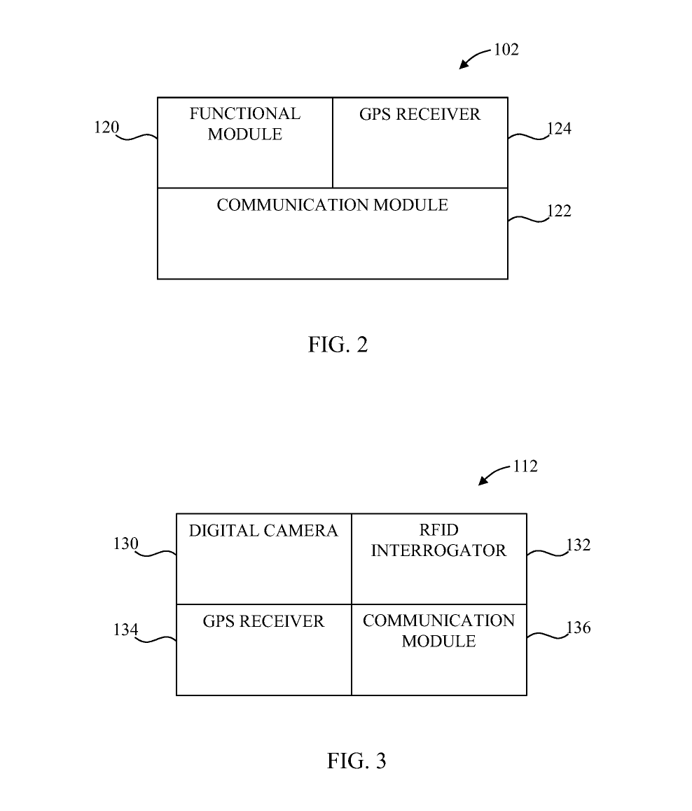

The medical device 102, also depicted in FIG. 2, may be for example a motorized wheelchair, a location monitoring system, a blood pressure monitoring system, a glucose monitoring system, an aspirator, a defibrillator, a continuous positive airway pressure (CPAP) system, or the like. The medical device 102 includes a functional module 120, a communication module 122, and a GPS receiver 124. The functional module 120 includes components used for the primary function of the medical device 102 such as diagnosing, monitoring, or treating a disease. Thus, in the case of a CPAP device, the functional module 120 includes an air pump (not shown) that operates under the control of a processor (not shown) executing program instructions stored in a memory (not shown).

The communication module 122 provides a communication link between the medical device 102 and the patient management database 104. The communication module 122 may be a wireless connection or may be configured to be wired into a communication network. Accordingly, the communication link with the patient management database 104 in some embodiments is established automatically while in other embodiments the communication link is established only on an as-needed basis as discussed more fully below.

The patient management database 104 is operably connected to and maintained by the care manager application 106. The patient management database 104 stores individual medical device data which is received from the medical device 102. Individual medical device data may include software version data, usage data, configuration data, etc.

The care manager application 106 is operated by the care manager providing the medical device 102 to a user. The care manager application 106 includes various rules governing the use of the medical device including authorization for the device to be used as discussed more fully below.

The service application 108 is controlled by a service manager who is responsible for field technicians who in turn provide services for the medical device 102. The service application 108 controls/maintains the device master record and service database 110. The device master record and service database 110 includes, for example, the various software versions used in the medical device 102 as well as a record of the appropriate software version to be installed on a particular type of medical device 102. The device master record and service database 110 further includes data related to refurbishment processes and maintenance processes that are appropriate for the medical device 102.

The refurbishment device 112 is further depicted in FIG. 3. The refurbishment device 112 includes a digital camera 130, a radio frequency identification (RFID) interrogator 132, a GPS receiver 134, a communication module 136, and a user interface 138. The communication module 136 is configured to establish communications with both the device master record and service database 110 and the medical device 102 as discussed more fully below.

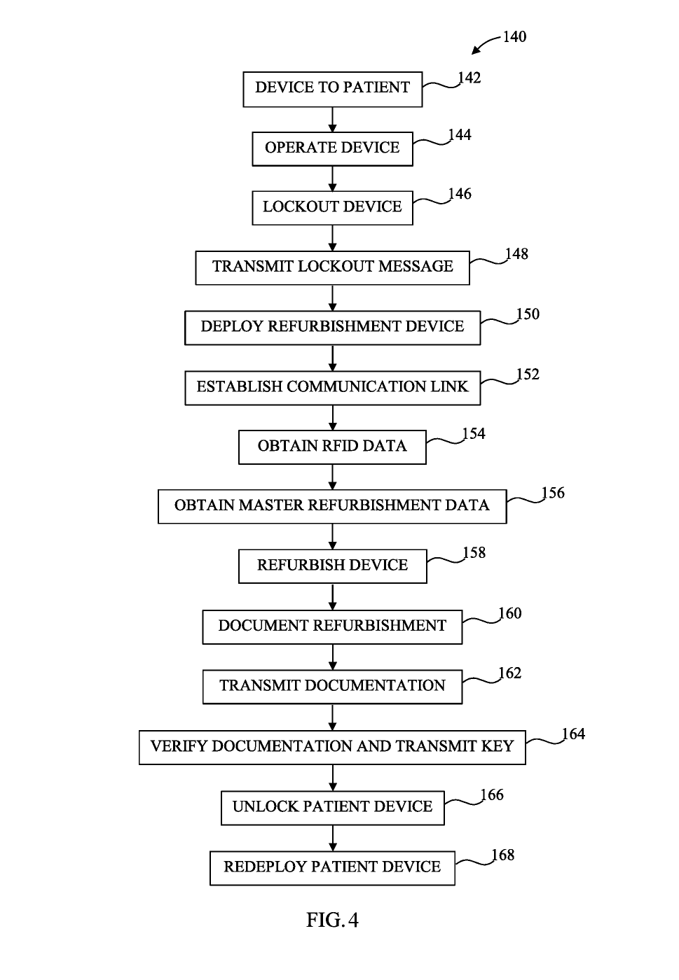

Additional details of the medical device quality compliance system 100 are provided along with discussion of a refurbishment/repair process 140 of FIG. 4. The process 140 begins at block 142 when the medical device 102 is provided to a patient. When the medical device 102 is initially provided, data related to the medical device 102 is stored in the medical device management database 104 which is maintained by the care manager application 106. The patient then uses the medical device 102 (block 144)

At block 146, the medical device 102 is locked-out of service. A medical device 102 may be locked-out of service autonomously in response to a predetermined condition or in response to a lockout command from the care manager application 106. For example, if a medical device 102 has exceeded a predetermined number of uses without required maintenance, the medical device 102 may autonomously lockout further operation of the device. Likewise, if a significant fault in the functional module 120 is detected, the medical device 102 may autonomously lockout further operation. In other embodiments, the care manager application 106 can control the medical device 102 to a locked-out condition for one or more of the above reasons, upon expiration of a service agreement, when a patient is dis-enrolled, when the patient no longer needs the medical device 102, etc.

After the medical device 102 has been locked-out, a notification is sent to the service application 108 that the medical device 102 has been locked-out (block 148). In one embodiment, the lockout message is transmitted from the medical device 102 to the patient management database 104, to the device master record and service database, and then to the service application 108. In another embodiment, the care manager application 106 initiates the lockout message. Depending upon the particular embodiment, the lockout message may include a request for service. The lockout message may include data indicating the reason that the medical device 102 has been locked-out. Thus, the lockout message may indicate a need for cleaning the previous patient data prior to providing the medical device 102 to a subsequent patient, a need for providing the latest software upgrade, a need to replace a component, or the need for retesting the medical device.

Once the medical device 102 is locked-out, the medical device 102 cannot be further operated until a key is provided by the service application 108. In order to accomplish unlocking of the medical device 102, an operator or field technician with the refurbishment device 112 is deployed to the location of the medical device 102 (block 150). At block 152, the refurbishment device 112 establishes communication with the medical device 102. Establishment of communication in some embodiments is accomplished by a hardwire connection between the refurbishment device 112 and the medical device 102. In other embodiments, the communication is wireless.

The refurbishment device 112 then uses the RFID interrogator 132 to interrogate the medical device 102 to obtain identification of the medical device 102. In some embodiments, the identification data is used to verify the correct medical device 102 is being refurbished by confirming the identity of the medical device 102 with identification data received from the care manager application 106. In some embodiments, the identification data is stored in a memory and transmitted to the refurbishment device 112 through the communication module 122.

Once the medical device 102 has been identified at block 154, the refurbishment device 112 establishes communication with the device master record and service database 110. The device master record and service database 110 provides the most recent refurbishment/repair data for the particular type or model of medical device 102 to the refurbishment device 112 (block 156). In some embodiments, this data is provided prior to block 150.

The data provided to the refurbishment device 112 from the device master record and service database 110 includes a check list of processes involved in a refurbishment operation. The checklist may include steps related to upgrading software, replacing components, testing components, performing required regulatory checks, or performing maintenance on components. Consequently, as refurbishment/service is performed (block 158), the field technician confirms the refurbishment/service is conducted using the user interface 138 and the checklist(s) (block 160). Other refurbishment/service steps are verified electronically by the refurbishment device 112. For example, proper installation of software upgrades may be verified electronically.

In order to provide additional quality assurance, the RFID data obtained by the RFID interrogator is electronically affixed to the checklist. Thus, there is an electronic record of the precise medical device 102 which has been refurbished/serviced.

One step in the checklists may require the use of the digital camera 130 to obtain images of the medical device 102. The physical condition/status of the medical device 102 may thus be documented. Additionally, images may be acquired at various steps in component disassembly/repair.

The documentation of the refurbishment/service may further be appended using the GPS receivers 124 and 134. Data from the GPS receivers 124 and 134 can be used to confirm the amount of time that the medical device 102 and the refurbishment device 112 were in proximity. Additionally, data associated with the communication link between the two devices can be used for the same purpose.

Once all of the necessary repairs/testing/maintenance has been properly documented using the refurbishment device 112, the field technician digitally signs a field service record including all of the documentation of the refurbishment/service. The signed documentation is communicated to the device master record and service database 110 (block 162). Data indicating the present state of the medical device 102 is further communicated to the patient management database 104. This data may be transmitted from the device master record and service database 110 or from the medical device 102.

Along with the electronic documentation, the refurbishment device 112 transmits an “unlock” request to the service application 108. If the documentation satisfies all of the requirements, the service application 108 transmits a key to the refurbishment device 112 which can unlock the medical device 102 block 164. Transmission of an unlock key may further be dependent upon acquiring a new service agreement, a new prescription, etc. At block 166, the refurbishment device 112 uses the key to unlock the medical device 102.

Once the medical device 102 has been unlocked, the medical device 102 is returned to service, either at the original user location or at a different location.

The above described embodiment thus provides a quality compliance system and method for the refurbishment process on a medical device which ensures that a refurbishment/service/maintenance process is properly performed on a medical device before the medical device is reused or redeployed to another patient. In different embodiments, the various steps may be performed in different orders. Moreover, depending upon the particular embodiment, some of the steps may be modified, combined, or omitted.

The processes which can be documented by the above described embodiments include data cleaning process, device cleaning process, identity confirmation operations, device testing processed, and software updating process.

In one embodiment, a locked medical device triggers a message to a field server (service application) indicating that the medical device is locked and also sends data explaining the basis for locking the medical device. The basis may be a need for cleaning patient data, a need for providing a software upgrade, or a need for retesting the medical device. A refurbishment device documents the refurbishing process electronically or manually. The refurbishment device checks the identity of the medical device and the status of the process steps taken after coupling with the medical device. The refurbishment device has a digital camera to confirm the appearance and the cleaning operation of the medical device. The location of the operator during the refurbishment operation is confirmed with a GPS receiver attached to the refurbishment device.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A quality compliance system for a medical device, comprising:
at least one medical device configured to diagnose, monitor, or treat a medical condition, the at least one medical device configured to lockout operation of the at least one medical device;
a refurbishment device configured to (i) establish a communication link with the at least one medical device, (ii) generate electronic documentation of a maintenance or service procedure on the at least one medical device, (iii) provide for associating a digital signature of an operator with the generated electronic documentation, (iv) transmit the digital signature and generated electronic documentation, and (v) unlock the at least one medical device with a received key; and
a service application configured to (i) receive the transmitted digital signature and generated electronic documentation, (ii) verify the transmitted digital signature and generated electronic documentation, and (iii) transmit the key to the refurbishment device upon verification of the transmitted digital signature and generated electronic documentation.

2. The system of claim 1, wherein the refurbishment device is further configured to (i) display at least one checklist associated with the maintenance or service procedure, (ii) receive an input from the operator in response to the displayed checklist, and (iii) generate the electronic documentation using the received input.

3. The system of claim 2, wherein:
the refurbishment device comprises a digital camera; and
the received input comprises a digital image obtained using the digital camera.

4. The system of claim 2, wherein the refurbishment device is further configured to (i) obtain an identification of the at least one medical device from the at least one medical device, (ii) obtain a software modification for the at least one medical device based upon the obtained identification, and (iii) transmit the obtained software modification to the at least one medical device.

5. The system of claim 4, wherein the refurbishment device includes a radio frequency identification (RFID) interrogator and the refurbishment device is configured to obtain the identification of the at least one medical device using the RFID interrogator.

6. The system of claim 4, wherein the at least one medical device is configured for autonomous lockout based upon a predetermined condition.

7. The system of claim 4, wherein the at least one medical device is configured for remote lockout in response to a lockout command from the service application.

8. The system of claim 4, wherein the at least one medical device is configured to transmit a lockout message in response to the at least one medical device being locked-out, the lockout message including data identifying the reason for which the at least one medical device was locked-out.

9. The system of claim 8, wherein the refurbishment device includes a global positioning system (GPS) receiver, and the refurbishment device is further configured to generate the electronic documentation using the received input.

10. The system of claim 2, wherein the maintenance or service procedure comprises one or more of a data cleaning process, a device cleaning process, a device testing process, and a software modification process.

11. A method of ensuring quality compliance for a medical device, comprising:
providing a medical device configured to diagnose, monitor, or treat a medical condition;
locking out operation of the medical device;
providing a refurbishment device;
establishing a communication link between the refurbishment device and the medical device;
generating electronic documentation of a maintenance or service procedure on the medical device using the refurbishment device;
associating a digital signature of an operator with the generated electronic documentation using the refurbishment device;
transmitting the digital signature and generated electronic documentation to a service application using the refurbishment device;
verifying the transmitted digital signature and generated electronic documentation with the service application;
transmitting a key from the service application to the refurbishment device upon verification of the transmitted digital signature and generated electronic documentation; and
unlocking the medical device with the key using the refurbishment device.

12. The method of claim 11, further comprising:
displaying at least one checklist associated with the maintenance or service procedure with the refurbishment device;
receiving an input from the operator in response to the displayed checklist with the refurbishment device; and
generating the electronic documentation using the received input.

13. The method of claim 12, wherein receiving an input comprises:
receiving a digital image obtained using a digital camera provided with the refurbishment device.

14. The method of claim 12, further comprising:
obtaining an identification of the medical device from the medical device using the refurbishment device;
obtaining a software modification for the medical device based upon the obtained identification using the refurbishment device; and
transmitting the obtained software modification from the refurbishment device to the medical device.

15. The method of claim 11, further comprising:
obtaining an identification of the medical device using a radio frequency identification (RFID) interrogator in the refurbishment device.

16. The method of claim 11, wherein locking out operation of the medical device comprises;
autonomously locking out operation of the medical device based upon a predetermined condition sensed by the medical device.

17. The method of claim 11, further comprising:
transmitting a lockout command from a service application to the medical device.

18. The method of claim 11, further comprising:
transmitting a lockout message from the medical device in response to the medical device being locked-out, the lockout message including data identifying the reason for which the medical device was locked-out.

19. The method of claim 11, wherein generating electronic documentation further comprises:
generating the electronic documentation using received input from a global positioning system (GPS) receiver.

20. The method of claim 11, wherein the maintenance or service procedure comprises one or more of a data cleaning process, a device cleaning process, a device testing process, and a software modification process.
